(19) United States
(12) Patent Application Publication
(10) Pub. No.: US 2021/0256374 A1
(43) Pub. Date: Aug. 19, 2021

(54) METHOD AND APPARATUS WITH NEURAL NETWORK AND TRAINING

(71) Applicants: Samsung Electronics Co., Ltd, Suwon-si (KR); Korea Advanced Institute of Science and Technology, Daejeon (KR)

(72) Inventors: Sung Ju HWANG, Seongnam-si (KR); Saehoon KIM, Seoul (KR); Eunho YANG, Daejeon (KR); Jaehong YOON, Daejeon (KR)

(73) Assignees: Samsung Electronics Co., Ltd, Suwon-si (KR); Korea Advanced Institute of Science and Technology, Daejeon (KR)

(21) Appl. No.: 17/145,876

(22) Filed: Jan. 11, 2021

Related U.S. Application Data
(60) Provisional application No. 62/976,528, filed on Feb. 14, 2020.

(30) Foreign Application Priority Data
Aug. 19, 2020 (KR) 10-2020-0104036

(51) Int. Cl. G06N 3/08; G06N 3/04

(52) U.S. Cl. CPC G06N 3/08; G06N 3/04

(57) ABSTRACT

A processor-implemented neural network method includes: determining an adaptive parameter and an adaptive mask of a current task to be learned among a plurality of tasks of a neural network; determining a model parameter of the current task based on the adaptive parameter, the adaptive mask, and a shared parameter of the plurality of tasks; and training the model parameter and an adaptive parameter of a previous task with respect to the current task, wherein the adaptive parameter of the previous task and the shared parameter are trained with respect to the previous task.

### CROSS-REFERENCE TO RELATED APPLICATIONS

This application claims the benefit under 35 USC 119(e) of U.S. Provisional Application No. 62/976,528 filed on Feb. 14, 2020, and the benefit under 35 USC 119(a) of Korean Patent Application No. 10-2020-0104036 filed on Aug. 19, 2020, in the Korean Intellectual Property Office, the entire disclosures of which are incorporated herein by reference for all purposes.

### BACKGROUND

### 1. Field

The following description relates to a method and apparatus with a neural network and training.

### 2. Description of Related Art

A neural network may have an operation structure in which a large number of processing elements with simple functions are connected in parallel, and may be used to solve issues that are hard to solve by the existing methods. To classify input patterns into predetermined groups, the neural network may implement learning or training. The neural network may have a generalization ability to generate relatively correct outputs for input patterns yet to be used for training based on training results.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented neural network method includes: determining an adaptive parameter and an adaptive mask of a current task to be learned among a plurality of tasks of a neural network; determining a model parameter of the current task based on the adaptive parameter, the adaptive mask, and a shared parameter of the plurality of tasks; and training the model parameter and an adaptive parameter of a previous task with respect to the current task, wherein the adaptive parameter of the previous task and the shared parameter are trained with respect to the previous task.

The training may include training the adaptive parameter of the previous task such that a change in a model parameter of the previous task is minimized as the shared parameter is trained with respect to the current task.

The training may include training the model parameter based on training data of the current task.

The determining of the model parameter may include determining the model parameter of the current task by applying the adaptive mask of the current task to the shared parameter and then adding the adaptive parameter to a result of the applying.

The applying may include a vector-wise multiplication between the shared parameter and the adaptive mask of the current task.

The determining of the adaptive parameter and the adaptive mask may include determining the adaptive parameter based on the shared parameter trained with respect to the previous task, and determining the adaptive mask at random.

The determining of the adaptive parameter and the adaptive mask, the determining of the model parameter, and the training may be iteratively performed with respect to each of the plurality of tasks.

The method may include: grouping a plurality of adaptive parameters of the plurality of tasks into a plurality of groups; and decomposing each of the adaptive parameters into a locally shared parameter shared by adaptive parameters grouped into a same group and a second adaptive parameter sparser than the respective adaptive parameter, based on whether elements included in each of the adaptive parameters grouped into the same group satisfy a predetermined condition.

The model parameter of the current task may be determined based on the shared parameter, the locally shared parameter of the group to which the current task belongs, and a second adaptive parameter and the adaptive mask of the current task.

The predetermined condition may be corresponding elements included in each of the adaptive parameters grouped into the same group having a value difference less than or equal to a threshold.

The grouping may include grouping the plurality of adaptive parameters based on K-means clustering, such that adaptive parameters of the plurality of adaptive parameters corresponding to similar tasks are grouped into a same group among the plurality of groups.

A structure of the neural network may be maintained unchanged, and a connection weight between nodes included in the neural network may be determined based on the model parameter.

The method may include obtaining output data based on the trained model parameter and input data to be inferred.

A non-transitory computer-readable storage medium may store instructions that, when executed by a processor, configure the processor to perform the method.

In another general aspect, a processor-implemented neural network method includes: selecting an adaptive parameter and an adaptive mask of a target task to be performed among a plurality of tasks of a neural network; determining a model of the target task based on the adaptive parameter, the adaptive mask, and a shared parameter of the plurality of tasks; and obtaining output data from the model by inputting input data to be inferred into the determined model.

The determining of the model may include determining the model parameter of the target task by applying the adaptive mask of the target task to the shared parameter and adding the adaptive parameter to a result of the applying, and determining a connection weight between nodes included in the neural network based on the model parameter.

The adaptive parameter may be among adaptive parameters of the plurality of tasks grouped into a plurality of groups, and the adaptive parameter may be determined based on a locally shared parameter of a group to which the target task belongs and a second adaptive parameter corresponding to the target task and being sparser than the adaptive parameter.

An adaptive parameter of a task to be removed from among the plurality of tasks may be deleted.

The plurality of tasks may have a same data type to be input into the neural network.

In another general aspect, a neural network apparatus includes: one or more processors configured to: determine an adaptive parameter and an adaptive mask of a current task to be learned among a plurality of tasks of a neural network, determine a model parameter of the current task based on the adaptive parameter, the adaptive mask, and a shared parameter of the plurality of tasks, and train the model parameter and an adaptive parameter of a previous task with respect to the current task, wherein the adaptive parameter of the previous task and the shared parameter are trained with respect to the previous task.

For the training, the one or more processors may be configured to train the adaptive parameter of the previous task such that a change in a model parameter of the previous task is minimized as the shared parameter is trained with respect to the current task.

For the training, the one or more processors may be configured to train the model parameter based on training data of the current task.

For the determining of the model parameter, the one or more processors may be configured to determine the model parameter of the current task by applying the adaptive mask of the current task to the shared parameter and then adding the adaptive parameter thereto.

In another general aspect, a neural network apparatus includes: one or more processors configured to: select an adaptive parameter and an adaptive mask of a target task to be performed among a plurality of tasks of a neural network, determine a model of the target task based on the adaptive parameter, the adaptive mask, and a shared parameter of the plurality of tasks, and obtain output data from the model by inputting input data to be inferred into the determined model.

In another general aspect, a processor-implemented neural network method includes: determining a model parameter of a current task, among a plurality of tasks of a neural network, based on an adaptive parameter and an adaptive mask of the current task, and a previously-trained shared parameter of the plurality of tasks; training, based on training data of the current task, the model parameter of the current task and a previously-trained adaptive parameter of a previous task with respect to the current task; and redetermining a previously-determined model parameter of the previous task based on the trained adaptive parameter of the previous task.

Other features and aspects will be apparent from the following detailed description, the drawings, and the claims.

### BRIEF DESCRIPTION OF THE DRAWINGS

FIGS. 1 and 2 illustrate examples of continual learning.

FIG. 3 illustrates an example of parameters that change as continual learning is performed.

FIGS. 4 to 7 illustrate examples of parameter decomposition based on hierarchical knowledge consolidation.

FIG. 8 illustrates an example of a method of training a neural network.

FIG. 9 illustrates an example of a method of processing data using a neural network.

FIG. 10 illustrates an example of a training apparatus.

FIG. 11 illustrates an example of a data processing apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art, after an understanding of the disclosure of this application, may be omitted for increased clarity and conciseness.

Although terms of “first” or “second” are used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the present disclosure, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. Likewise, expressions, for example, “between” and “immediately between” and “adjacent to” and “immediately adjacent to” may also be construed as described in the foregoing.

The terminology used herein is for the purpose of describing particular examples only and is not to be limiting of the disclosure. As used herein, the singular forms “a”, “an”, and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, integers, steps, operations, elements, components, numbers, and/or combinations thereof, but do not preclude the presence or addition of one or more other features, integers, steps, operations, elements, components numbers, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Unless otherwise defined, all terms, including technical and scientific terms, used herein have the same meaning as commonly understood by one of ordinary skill in the art to which this disclosure pertains consistent with and after an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, examples will be described in detail with reference to the accompanying drawings. The following specific structural or functional descriptions are exemplary to merely describe the examples, and the scope of the examples is not limited to the descriptions provided in the present disclosure. Various changes and modifications can be made thereto by those of ordinary skill in the art based on an understanding of the disclosure of the present application. Like reference numerals in the drawings denote like elements, and a known function or configuration will be omitted herein.

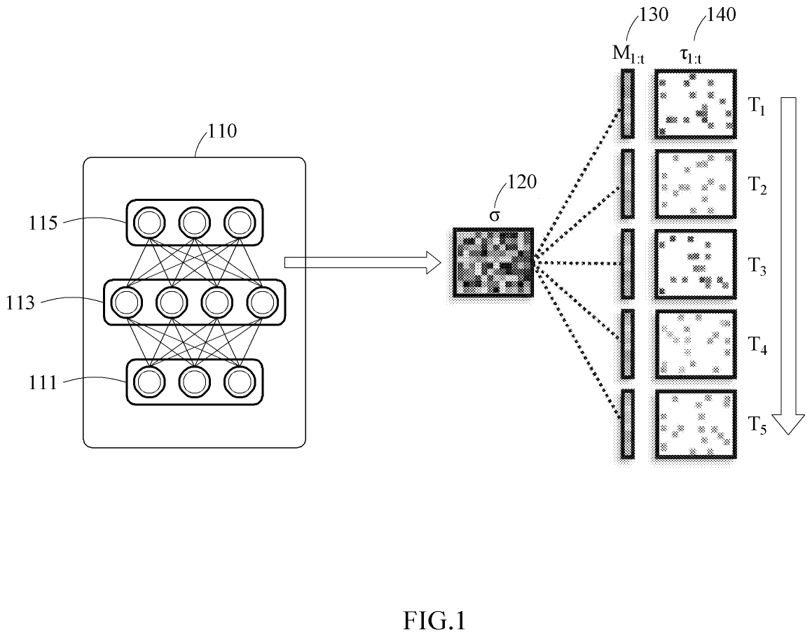

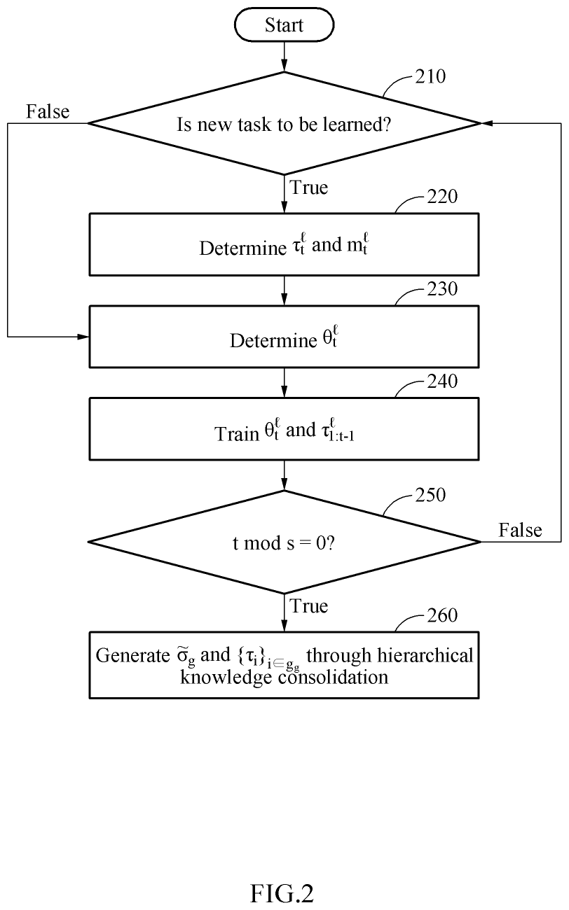

FIGS. 1 and 2 illustrate examples of continual learning.

Referring to FIG. 1, a neural network 110 may include a plurality of layers 111, 113, and 115. In an example, the neural network 110 may include an input layer 111, a hidden layer 113, and an output layer 115. Each of the layers 111, 113, 115 may include a plurality of nodes. Each node may be a calculation unit having one or more inputs and an output, and the nodes may be connected to each other.

The input layer 111 may include one or more nodes into which input data are directly input, not through a link in a relationship with other nodes of a previous layer. The output layer 115 may include one or more nodes having no output node connected with other nodes of a subsequent layer. The hidden layer 113 may include remaining layer(s) of the neural network 110, other than the input layer 111 and the output layer 115. Although FIG. 1 illustrates a single hidden layer 113 for ease of description, the neural network 110 may be a deep neural network where the hidden layer 113 includes a plurality of hidden layers. The hidden layer 113 may include nodes corresponding to input nodes or output nodes in a relationship with other nodes. The neural network 110 shown in FIG. 1 is provided as an example for ease of description, and thus the structure of the neural network 110 should not be interpreted as limiting the scope of examples.

The neural network used in the example may be provided in various structures. The number of hidden layers included in the neural network 110, the number of nodes included in each layer, and/or the connection between nodes may vary depending on an example.

An output of a node included in a layer may be input into one or more nodes of another layer. For example, an output of a node included in the input layer 111 may be transferred to the nodes of the hidden layer 113. The nodes may be connected to each other by “links”, and nodes connected through a link may form a relative relationship of an input node and an output node. The concept of an input node and an output node is relative, and a predetermined node which is an output node in the relationship with a node may be an input node in the relationship with another node, and vice versa.

A connection weight may be set for a link between nodes. For example, a predetermined connection weight may be set for a link between nodes, and the connection weight may be adjusted or changed. Neural networks having different connection weights may have different characteristics. The connection weight may amplify, reduce, or maintain a relevant data value, thereby determining a degree of influence of the data value on a final result. The connection weight may correspond to a model parameter of the neural network 110.

In a relationship of an input node and an output node connected through a link, an output value of the output node may be determined based on data input into the input node and a connection weight of the link between the input node and the output node. For example, when one or more input nodes are connected to a single output node by respective links, an output value of the output node may be determined based on input values input into the one or more input nodes and connection weights of the links between the one or more input nodes and the output node.

Each node included in the hidden layer 113 may receive an output of an activation function related to weighted inputs of the nodes included in a previous layer. The weighted inputs may be obtained by multiplying inputs of the nodes included in the previous layer by connection weights. The activation function corresponds to, for example, a sigmoid, a hyperbolic tangent (tanh), or a rectified linear unit (ReLU). The weighted inputs of the nodes included in the previous layer are input into each node included in the output layer 115. A process of inputting weighted data from a predetermined layer to the next layer may be referred to as propagation.

The neural network 110 as described above may be implemented by a hardware device such as a computer system executing instructions. The neural network 110 may include, for example, a fully connected network, a deep convolutional network, and/or a recurrent neural network. The neural network 110 may be used in various fields such as object recognition, speech recognition, machine translation, pattern recognition, and/or computer vision.

The neural network 110 may use continual learning techniques to process various tasks. For example, among the continual learning techniques, expandable continual learning techniques may include a progressive neural network (PGN), reinforced continual learning (RCL), a dynamically expandable network (DEN), and the like. In general, continual learning may be an online multi-task learning method, and may be a technique for obtaining a single model capable of finally performing various tasks in an environment where new data and new tasks are sequentially given. A typical continual learning technique may perform inference for many tasks using a single model but may have an issue of catastrophic forgetting, the tendency of a model to forget knowledge learned for earlier tasks as it learns on new tasks. Further, as the number of tasks learned by the typical continual learning technique increases, the memory and/or processing power cost for effective training increases rapidly.

According to one or more embodiments, the occurrence of catastrophic forgetting described above may be effectively prevented by decomposing a model parameter (e.g., a connection weight) into a shared parameter σ 120 and an adaptive parameter τ1:t 140 at each layer included in the neural network 110 and retroactively training an adaptive parameter of a previous task as a new task is trained. The shared parameter σ 120 may be a parameter shared by a plurality of tasks T₁ to T₅ and may include generic knowledge about the plurality of tasks.

The adaptive parameter τ1:t 140 may be knowledge about each task that is not expressed by the shared parameter τ 120. Through maximized utilization of the shared parameter τ 120 during training, the adaptive parameter τ1:t 140 may be determined sparsely, which may effectively suppress a radical increase in the size of the neural network 110 caused by an increase in the number of tasks. An adaptive mask M_{1:t} 130 may correspond to an attention for accessing only related knowledge in the shared parameter for processing a corresponding task.

FIG. 1 shows an example in which the neural network 110 is sequentially trained on from the first task T₁ to the fifth task T₅. The plurality of tasks T₁ to T₅ used for continual learning of the neural network 110 may be tasks of the same data type that are input into the neural network 110. For example, when a data type of input data of the neural network 110 is an image, the plurality of tasks T₁ to T₅ may each correspond to recognition of a respective predetermined object included in the input image, classification, and the like. For example, the first task T₁ may be a task of recognizing a sedan object in the input image, and the third task T₃ may be a task of recognizing a truck object in the input image. A model parameter of the neural network 110 at a t-th task Tₜ of performing such a predetermined task may be determined based on the shared parameter σ 120, the adaptive mask Mₜ, and the adaptive parameter τₜ. Through the method described above, even when the number of tasks to be learned increases, the neural network 110 of one or more embodiments may exhibit a fast learning speed through training based on a single objective function without changing the structure of the neural network 110. Further, the neural network 110 of one or more embodiments may exhibit performance with order-robustness in task learning.

Hereinafter, non-limiting examples of the continual learning of one or more embodiments will be described in further detail.

Referring to FIG. 2, a process of performing continual learning is illustrated.

In continual learning, a plurality of tasks {T₁, . . . , T_{T}} may be used in a random order for training a neural network. A dataset of a t-th task may be denoted as Dₜ={xₜⁱ, y_{y}ⁱ}ᵢ₌₁^{N}^{ₜ}. Here, xₜⁱ and yₜⁱ denote an i-th instance and label, respectively, among Nₜ examples. A corresponding dataset may be inaccessible after a step t of learning a t-th task. In step t, model parameters for the neural network may be given as Θₜ={θₜ^{l}}, where {θₜ^{l}} denotes weights for a layer l. The layer index l may be omitted when the context is clear.

To minimize the catastrophic forgetting described above and the increase in the size of the neural network caused by the increase in the number of tasks to be learned, a training apparatus of one or more embodiments may decompose a model parameter θ of the neural network into a task-shared parameter a and a task-adaptive parameter matrix τ. That is, a model parameter for the t-th task may be expressed by θₜ=σ⊗Mₜ+τₜ. In this example, ⊗ denotes a vector-wise multiplication, and Mₜ (e.g., a task-adaptive mask) may act as an attention for focusing only on the parts relevant for the corresponding task in the task-shared parameter σ. In summary, parameters used in continual learning may include a task-shared parameter σ∈ [symbol] N'M a task-adaptive parameter τ∈ [symbol] N×M, and a task-adaptive mask m∈ [symbol] M.

This parameter decomposition may allow easy control of the trade-off between semantic drift and predictive performance of a new task by imposing separate regularizations on decomposed parameters. For example, when training for a new task is initiated, the shared parameters a determined for the previous task may be properly updated and induced not to deviate far from the previous shared parameter σ^{(t-1)}. At the same time, the capacity of the adaptive parameter τₜ may be induced to be as small as possible, by making the adaptive parameter τₜ sparse.

In operation 210, a training apparatus may determine whether a current task to be learned corresponds to a new task. When the current task is a new task that has not been learned previously, operation 220 may be performed. Conversely, when the current task is a task being learned, operation 230 may be performed.

In operation 220, the training apparatus may determine an adaptive parameter τₜ and an adaptive mask Mₜ for the current task. For example, the adaptive parameter τₜ may be determined to be the same as the shared parameter a trained for a previous task. Further, the adaptive mask Mₜ may be determined at random.

In operation 230, the training apparatus may determine a model parameter θₜ^{l} for the current task. For the current task t, the model parameter may be determined by θₜ=σ⊗ [symbol] ₜ+τₜ. In this way, the training apparatus may determine the model parameter θₜ^{l} by applying the adaptive mask Mₜ to the shared parameter a and then adding the adaptive parameter τₜ thereto.

In operation 240, the training apparatus may train the model parameter θₜ^{l} and an adaptive parameter τ1:t−1 of the previous task with respect to the current task. Training may be performed based on an objective function expressed by Equation 1 below, for example. Through training performed based on a single objective function, a fast training speed may be achieved.

$${minimize}_{σ , {τ}_{1 : t} , {v}_{1 : t}} ℒ ( \{ σ ⊗ {ℳ}_{t} + {τ}_{t} \} ; {𝒟}_{t} ) + {λ}_{1} {\sum }_{i = 1}^{t} {‖ {τ}_{i} ‖}_{1} + {λ}_{2} {\sum }_{i = 1}^{t - 1} {‖ {θ}_{i}^{*} - ( σ ⊗ {ℳ}_{i} + {τ}_{i} ) ‖}_{2}^{2} \qquad Equation 1$$

In Equation 1, [symbol] denotes a loss function applied to a neural network. denotes an element-wise L1 norm defined on a matrix. λ₁ and λ₂ denote hyperparameters balancing the efficiency of catastrophic forgetting. For example, the training apparatus may use L2 transfer regularization to prevent catastrophic forgetting but may also use other types of regularizations such as elastic weight consolidation (EWC). For example, the adaptive mask Mₜ may correspond to a sigmoid function of a trainable parameter vₜ applied to output channels or nodes of the shared parameter σ in each layer. As described above, a model that decomposes a model parameter into a shared parameter and an adaptive parameter may be referred to as an additive parameter decomposition (APD) model.

In Equation 1, the first term [symbol] ({σ⊗ [symbol] ₜ+τₜ}; [symbol] ₜ) may reflect configuring a model for the current task t and training the model with a training dataset Dₜ. For example, the model may be trained to minimize a loss between output labels of training data and inference data obtained when an input instance included in training data for the current task is input into the corresponding model.

In Equation 1, the second term

$${λ}_{1} {\sum }_{i = 1}^{t} {‖ {τ}_{i} ‖}_{1}$$

is a penalty term that makes the adaptive parameter τ sparse, thereby pruning the adaptive parameter τ. Through this, even when the number of tasks to be learned increases, it is possible to effectively suppress an increase in the parameter size.

In Equation 1, the third term

$${λ}_{2} {\sum }_{i = 1}^{t - 1} {‖ {θ}_{i}^{*} - ( σ ⊗ {ℳ}_{i} + {τ}_{i} ) ‖}_{2}^{2}$$

may be for maintaining the original solutions learned for the previous task even when the shared parameter for the current task is trained and updated. A model parameter for the previous task (for example, a (t−1)-th task) is expressed by θₜ₋₁=σ⊗Mₜ₋₁+τₜ₋₁, wherein the task-shared parameter a may be properly updated when learning the current task (for example, a t-th task) is initiated. As a result, the model parameter θₜ₋₁ of the previous task is not maintained to be constant but changed. Thus, by reflecting the task-shared parameter a updated through training to the adaptive parameter τₜ₋₁ of the previous task in operation 240, the model parameter θₜ₋₁ of the previous task may be maintained to be constant. In Equation 1, the third term may be such a penalty term.

θ*ᵢ denotes a model parameter trained and determined for an i-th task. Here, i is less than t and denotes an i-th previous task. When a new t-th task is learned, model parameters θ*ᵢ of previous tasks may be all recovered through Equation 2 below, for example. θ*ᵢ may be fixed without being updated during training.

(θᵢ for task i<t): θ*ᵢ=σ^{(t-1)}⊗ [symbol] ᵢ^{(t-1)}+τᵢ^{(t-1)} Equation 2:

Further, σ⊗ [symbol] ᵢ+τᵢ may be updated such that θ*ᵢ is constrained to be as close to τ1:t−1 as possible (see the last term of Equation 1).

As such, retroactive learning of adaptive parameters τ1:t−1 of previous tasks may be performed at the parameter level without generating a separate model and without a training dataset. Through this, the training apparatus of one or more embodiments may effectively prevent parameter-level drift and catastrophic forgetting, and may generate a trained model with a high degree of order-robustness in task learning.

In operation 250, the training apparatus may determine whether a predetermined number of (for example, s) new tasks are performed. This is for hierarchical knowledge consolidation which is described later. When the predetermined number (for example, s) new tasks are yet to be learned, operation 210 may be performed again. Conversely, when the predetermined number (for example, s) new tasks are learned, operation 260 may be performed.

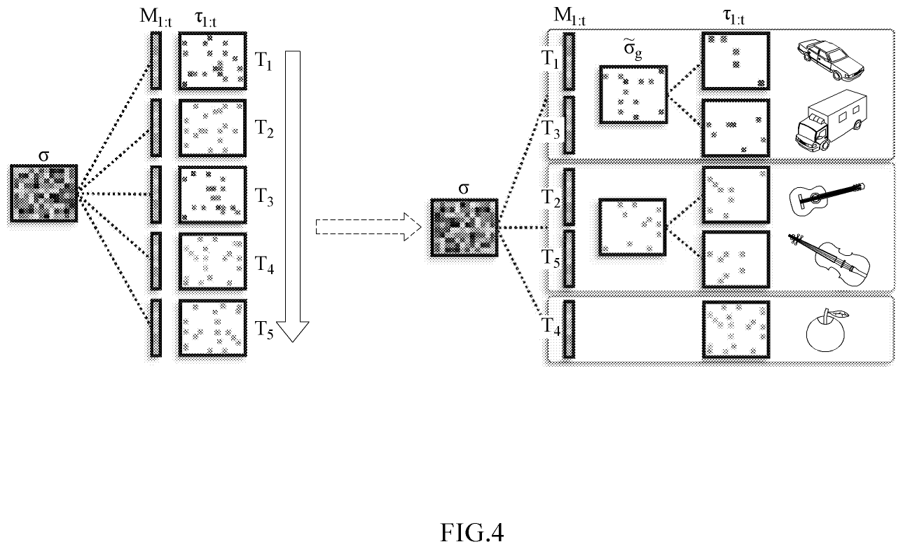

In operation 260, the training apparatus may perform hierarchical knowledge consolidation on adaptive parameters, thereby generating the adaptive parameter into a locally shared parameter \tilde{σ}_{g} and a second adaptive parameter J for the corresponding adaptive parameter. Examples of hierarchical knowledge consolidation will be described in further detail below with reference to FIGS. 4 to 7.

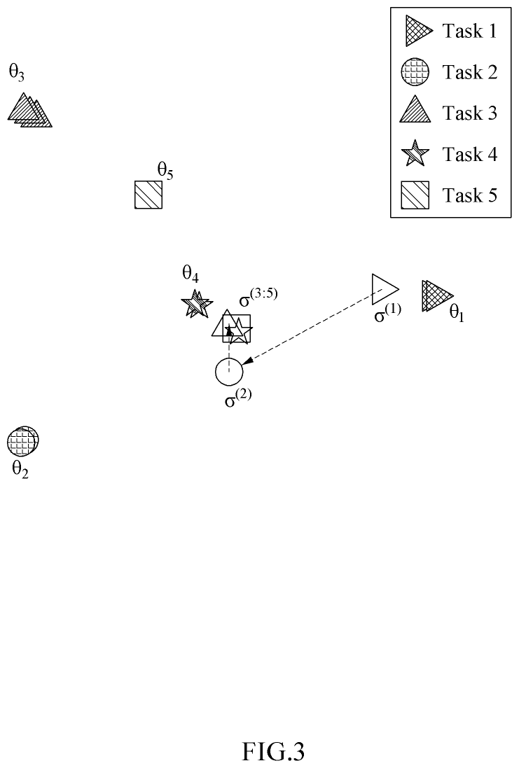

FIG. 3 illustrates an example of parameters that change as continual learning is performed.

Referring to FIG. 3, an example of updating parameters obtained through continual learning is illustrated. In FIG. 3, the symbols visually represent parameters through 2D projection, and the shapes of the symbols indicate corresponding tasks, where a hatched symbol denotes a model parameter of a corresponding task, an empty symbol denotes a shared parameter of a corresponding task, and a dashed arrow indicates a drift of a parameter in the parameter space as the model is trained. In this case, continual learning may be performed in an order from Task 1 to Task 5.

As shown in FIG. 3, as a neural network learns new tasks (e.g., from Task 1 to Task 5), the shared parameters may be updated to gradually converge to a point at which the distances to all the learned tasks are minimized, and the model parameters by the shared parameters and adaptive parameters may be maintained to be constant without a large fluctuation at the initial positions.

In continual learning, information on a predetermined task may be selectively removed due to the structural characteristics that there exists separately an adaptive parameter for each task. For example, when there is a corresponding task that is no longer needed during training or that hinders learning other major tasks, an adaptive parameter of the corresponding task may be deleted without affecting the performance for the remaining tasks, whereby information on the corresponding task may be easily removed. Through this, the training apparatus of one or more embodiments may achieve efficient training and storage space management. For example, when a predetermined product is discontinued, a task of recognizing and classifying the product may no longer be necessary. Thus, by deleting an adaptive parameter which is training information for the task, the training apparatus of one or more embodiments may efficiently manage the model and maintain the performance for other tasks. This makes advantages in lifetime learning scenarios.

FIGS. 4 to 7 illustrate examples of parameter decomposition based on hierarchical knowledge consolidation.

Referring to FIG. 4, an example of performing hierarchical knowledge consolidation by grouping a plurality of adaptive parameters for a plurality of tasks is illustrated. Hereinafter, for ease of description, input data may be an image and a task of recognizing an object included in the image may be performed through a neural network. In addition, this example may also be unlimitedly applied to a neural network that performs various tasks (e.g., recognition) based on speech, text, and the like.

The plurality of tasks may be related to similar targets to be recognized. For example, a first task T₁ of recognizing a sedan and a third task T₃ of recognizing a truck are partially similar in that targets to be recognized are vehicles. Further, a second task T₂ of recognizing a guitar and a fifth task T₅ of recognizing a violin are partially similar in that targets to be recognized are musical instruments. As such, similar tasks may have redundancy of information in adaptive parameters due to their characteristics. Setting the redundancy of information as a locally shared parameter \tilde{σ}_{g} may make the adaptive parameters τ1:t sparser. It may be verified that when compared to the adaptive parameters in a case where there is no locally shared parameter as shown on the left side of FIG. 4, the adaptive parameters in a case where there is a locally shared parameter as shown on the right side of FIG. 4 include sparser information. In this example, an adaptive mask M_{1:t} may be the same as that in the case where there is no locally shared parameter. As such, through such hierarchical knowledge consolidation, the semantic redundancy of task-adaptive parameters may be minimized, whereby the model size that increases as the number of tasks to be learned increases may also be minimized.

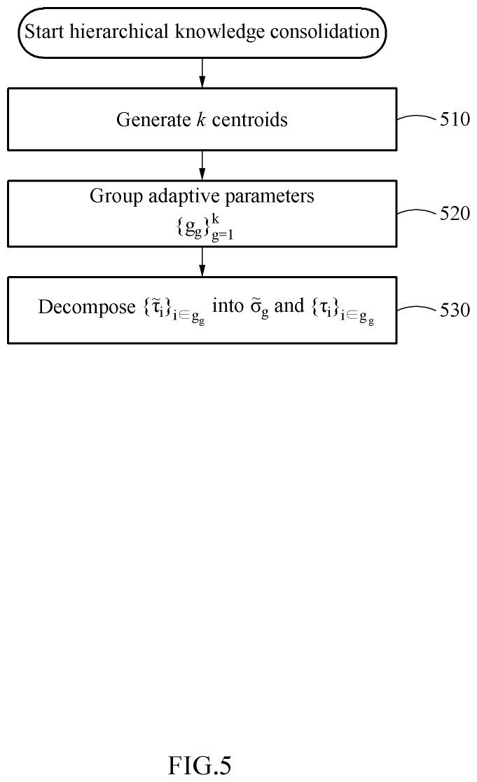

Referring to FIG. 5, a process of performing hierarchical knowledge consolidation is illustrated. As the number of tasks to be learned increases, it may be difficult for a typical training apparatus to effectively handle various task knowledge with only one shared parameter. Therefore, the training apparatus of one or more embodiments may effectively remove redundant knowledge remaining in adaptive parameters by utilizing the locally shared parameter which will be further described below, for example. As described in operation 250 of FIG. 2, such hierarchical knowledge consolidation may be performed for each s-th task.

In operation 510, a training apparatus may generate a plurality of centroids based on a plurality of adaptive parameters for a plurality of tasks. In operation 520, the training apparatus may group the plurality of adaptive parameters into a plurality of groups. In this case, K-means clustering may be used to group the adaptive parameters.

In operation 530, the training apparatus may decompose each of adaptive parameters grouped into the same group into a locally shared parameter \tilde{σ}_{g} and a second adaptive parameter {τᵢ}i∈g_{g} for a corresponding task.

In summary, each time the s-th task is learned, K-means clustering may be performed on previously trained adaptive parameters {τᵢ}ᵢ₌₁^{t} to group the tasks into K groups { [symbol] _{g}}_{g=1}^{K}. In addition, each of the previously trained adaptive parameters in the same group may be decomposed into the locally shared parameter g and the second adaptive parameter {τᵢ}i∈ [symbol] _{g} for the corresponding task, as shown in Equation 3 below, for example.

$$If max {\{ {τ}_{i , j} \}}_{i ∈ {ℊ}_{g}} - min {\{ {τ}_{i , j} \}}_{i ∈ {ℊ}_{g}} \leq β , \\ then {\{ {τ}_{i , j} \}}_{i ∈ {ℊ}_{g}} = 0 and {\tilde{σ}}_{g , j} = {μ}_{g , j} \\ Else , {\tilde{σ}}_{g , j} = 0 , \qquad Equation 3$$

In Equation 3, τ_{i,j} denotes a j-th element of an i-th adaptive parameter matrix, μ_{g} denotes the cluster centroid of a group [symbol] _{g}, and β denotes a threshold and may be set to a fairly small number. In other words, when the difference between the maximum and minimum values of j-th elements of adaptive parameters included in the same group is less than β which is a very small value, the values of the j-th elements of the adaptive parameters may be set to “0”, and the j-th element \tilde{σ}_{g,j} of the locally shared parameter may be set to “μ_{g,j}”. Through this, the training apparatus of one or more embodiments may make adaptive parameters for individual tasks sparser by generating a locally shared parameter as redundant knowledge within the same group.

In an example, the hierarchical knowledge consolidation described above may be performed for every s-th task, and the centroids of the groups may be initialized each time. In addition, each time the hierarchical knowledge consolidation is performed, the number of groups may be increased by k, such that a total of K+k groups may be determined. This may properly increase the number of groups as the number of tasks to be learned increases.

When a locally shared parameter is utilized for hierarchical knowledge consolidation, the objective function may be expressed as shown in Equation 4 below, for example.

$${minimize}_{σ , {τ}_{1 : t} , {v}_{1 : t}} ℒ ( \{ σ ⊗ {ℳ}_{t} + {τ}_{t} \} ; {𝒟}_{t} ) + {λ}_{1} {\sum }_{i = 1}^{t} {‖ {τ}_{i} ‖}_{1} + {λ}_{2} {\sum }_{i = 1}^{t - 1} {‖ {θ}_{i}^{*} - ( σ ⊗ {ℳ}_{i} + {\tilde{τ}}_{i} ) ‖}_{2}^{2} , \\ where {\tilde{τ}}_{i} = {τ}_{i} + {\tilde{σ}}_{g} for i ∈ {𝒢}_{g} \qquad Equation 4$$

In Equation 4, it may be verified that an adaptive parameter \tilde{τ}ᵢ of an i-th task is decomposed into a locally shared parameter \tilde{σ}_{g} and a sparser second adaptive parameter τᵢ corresponding to the i-th task.

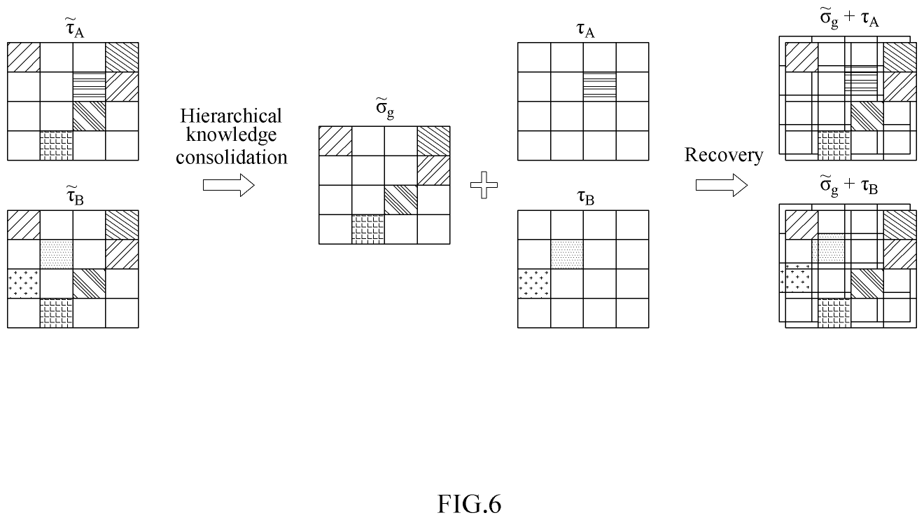

Referring to FIG. 6, an example of hierarchical knowledge consolidation and recovery among adaptive parameters \tilde{τ}_{A} and \tilde{τ}_{B} within the same group, a locally shared parameter \tilde{σ}_{g}, and second adaptive parameters τ_{A} and τ_{B} is illustrated. The adaptive parameters \tilde{τ}_{A} and \tilde{τ}_{B} within the same group may have elements having the same or very similar values (e.g., where the elements are determined to have same or very similar values when a difference between the values is less than or equal to a predetermined threshold), and such elements may be included in the locally shared parameter \tilde{σ}_{g} through hierarchical knowledge consolidation. Through this, redundancy of information may be excluded from the second adaptive parameters τ_{A} and τ_{B}, and thus the second adaptive parameters may be determined to be sparser than adaptive parameters \tilde{τ}_{A} and \tilde{τ}_{B}. By adding the locally shared parameter \tilde{σ}_{g} and the second adaptive parameters τ_{A} and τ_{B}, the existing adaptive parameters \tilde{τ}_{A} and \tilde{τ}_{B} may be recovered.

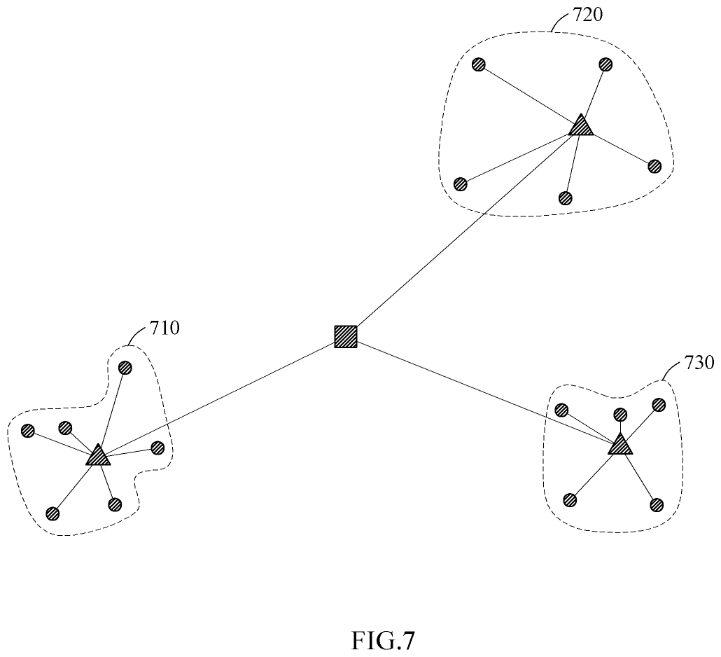

Referring to FIG. 7, an example of grouping by hierarchical knowledge consolidation is illustrated. In a parameter space shown in FIG. 7, a shared parameter may be indicated by a square, locally shared parameters may be indicated by triangles, and adaptive parameters may be indicated by circles. The adaptive parameters may be grouped into a plurality of groups 710 to 730, and each group may have a locally shared parameter including redundant information of adaptive parameters included in the corresponding group. Adaptive parameters for individual tasks may be made sparser through such hierarchical knowledge consolidation, whereby the scalability of the model may be improved.

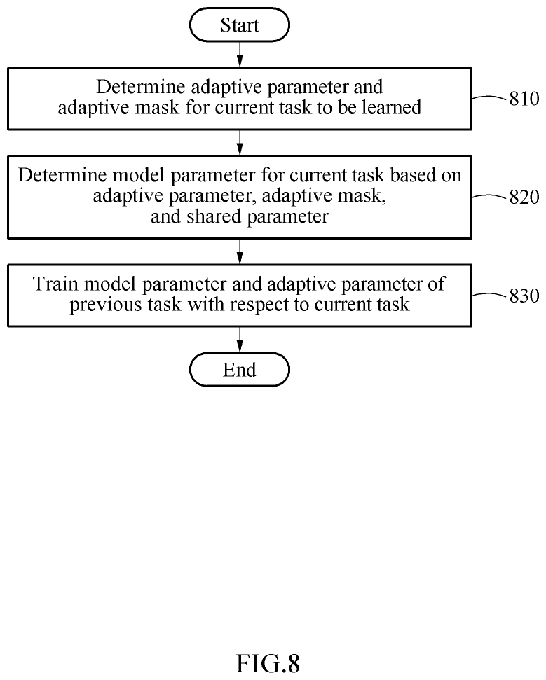

FIG. 8 illustrates an example of a method of training a neural network.

Referring to FIG. 8, a training method performed by a training apparatus is illustrated. In operation 810, the training apparatus may determine an adaptive parameter and an adaptive mask for a current task to be learned. In operation 820, the training apparatus may determine a model parameter for the current task based on the adaptive parameter, the adaptive mask, and a shared parameter for a plurality of tasks. In operation 830, the training apparatus may train the model parameter and an adaptive parameter of a previous task with respect to the current task. The adaptive parameter of the previous task and the shared parameter may be trained with respect to the previous task.

The descriptions provided with reference to FIGS. 1 to 7 may apply to the operations shown in FIG. 8, and thus further detailed descriptions will be omitted.

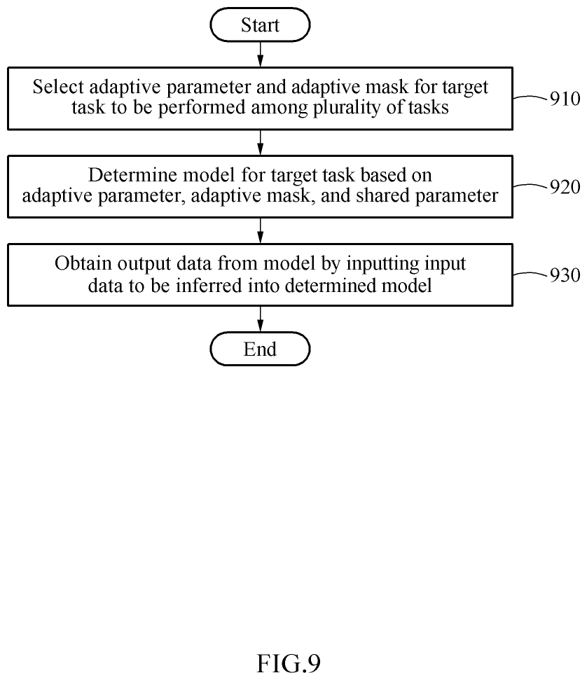

FIG. 9 illustrates an example of a method of processing data using a neural network.

Referring to FIG. 9, a data processing method performed by a data processing apparatus is illustrated.

In operation 910, the data processing apparatus may select an adaptive parameter and an adaptive mask for a target task to be performed among a plurality of tasks. For example, in response to a request for inference about a t-th task, the data processing apparatus may select an adaptive parameter and an adaptive mask for the t-th task, and a shared parameter from among parameters stored in a memory.

In operation 920, the data processing apparatus may determine a model for the target task based on the adaptive parameter, the adaptive mask, and a shared parameter for the plurality of tasks. For example, the data processing apparatus may determine a parameter of the model for performing the t-th task to be θₜ=σ⊗ [symbol] ₜ+τₜ. In this way, the data processing apparatus may determine the model parameter τₜ by applying the adaptive mask Mₜ to the shared parameter σ and then adding the adaptive parameter θₜ^{l} thereto.

In operation 930, the data processing apparatus may obtain output data from the model by inputting input data to be inferred into the determined model.

The descriptions provided with reference to FIGS. 1 to 8 may apply to the operations shown in FIG. 9, and thus further detailed descriptions will be omitted.

The training apparatus and the data processing apparatus described herein may be used in various fields such as image processing, object recognition, speech recognition, machine translation, machine interpretation, speech synthesis, and handwriting recognition, and may be applied to the design of continual learning-based large-scale artificial intelligence models. In addition, the training apparatus and the data processing apparatus may also be utilized when task-adaptive modeling is required in linear learning or deep learning networks.

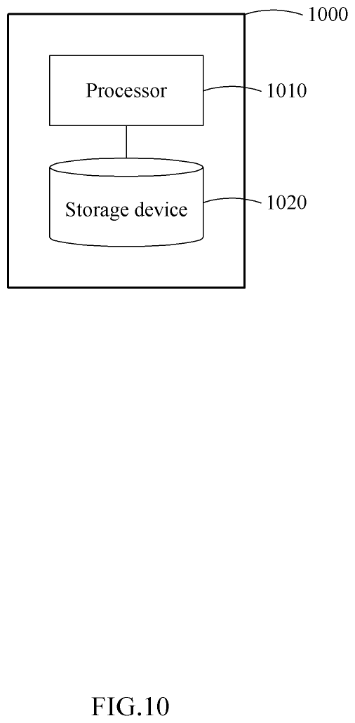

FIG. 10 illustrates an example of a training apparatus.

Referring to FIG. 10, a training apparatus 1000 may include a processor 1010 (e.g., one or more processors) and a storage device 1020 (e.g., including one or more memories).

The storage device 1020 may store information or data to be used for a processing operation of the training apparatus 1000. For example, the storage device 1020 may store training data used for training a neural network. Further, the storage device 1020 may store instructions to be executed by the processor 1010. The storage device 1020 may include computer-readable storage media, such as a random-access memory (RAM), a dynamic random-access memory (DRAM), a static random-access memory (SRAM), a magnetic hard disk, an optical disk, a flash memory, and an electrically programmable read-only memory (EPROM), or other types of computer-readable storage media known in the art.

The processor 1010 may control overall operations of the training apparatus 1000 and executes functions and/or instructions to be executed within the training apparatus 1000. The processor 1010 may perform a process of training a neural network based on training data, and perform the one or more operations described above in relation to the training process.

In an example, the processor 1010 may determine an adaptive parameter and an adaptive mask for a current task to be learned, determine a model parameter for the current task based on the adaptive parameter, the adaptive mask, and a shared parameter for a plurality of tasks, and train the model parameter and an adaptive parameter of a previous task with respect to the current task. The adaptive parameter of the previous task and the shared parameter are trained with respect to the previous task.

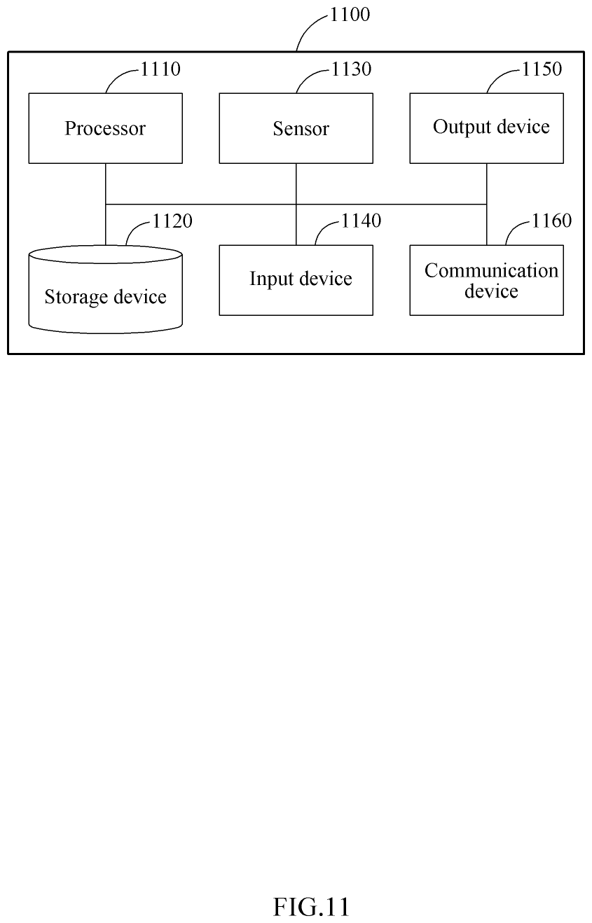

FIG. 11 illustrates an example of a data processing apparatus.

Referring to FIG. 11, a data processing apparatus 1100 may include a processor 1110 (e.g., one or more processors) and a memory 1120 (e.g., one or more memories). In some examples, the data processing apparatus 1100 may further include one or more of a sensor 1130, an input device 1140, an output device 1150, and a communication device 1160.

The storage device 1120 may store information or data necessary for a processing operation of the data processing apparatus 1100. For example, the data processing apparatus 1100 may store input data that is a subject of data processing. Further, the storage device 1120 may store instructions to be executed by the processor 1110. The storage device 1120 may include computer-readable storage media, such as a RAM, a DRAM, a SRAM, a magnetic hard disk, an optical disk, a flash memory, and an EPROM, or other types of computer-readable storage media known in the art.

The processor 1110 may control overall operations of the data processing apparatus 1100 and execute functions and/or instructions to be executed within the data processing apparatus 1100. The data processing apparatus 1100 may include one or more processors 1110, and the processor 1110 may include, for example, a neural processing unit (NPU), a graphics processing unit (GPU), a tensor processing unit (TPU), and the like. The processor 1110 may perform a process of processing the input data using the neural network, and perform the one or more operations described above in relation to the corresponding process.

In an example, the processor 1110 may select an adaptive parameter and an adaptive mask for a target task to be performed among a plurality of tasks, determine a model for the target task based on based on the adaptive parameter, the adaptive mask, and a shared parameter for the plurality of tasks, and obtain output data from the model by inputting input data to be inferred into the determined model.

The sensor 1130 may include one or more sensors. For example, the sensor 1130 may include an image sensor, a speech sensor, a radar sensor, and a measurement sensor. Image data, speech data, or radar data acquired by the sensor 1130 may be used as the input data described above.

The input device 1140 may receive a user input from a user. The input device 1060 may include, for example, a keyboard, a mouse, a touch screen, a microphone, or any other device that detects the input from the user and transmits the detected input.

The output device 1150 may provide an output of the data processing apparatus 1100 to the user through a visual, auditory, or tactile method. The output device 1150 may include, for example, a display, a speaker, a lighting device, a haptic device, or any other device that provides the output to the user.

The communication device 1160 may communicate with an external device through a wired or wireless network. For example, the communication device 1160 may communicate with other external devices using a wired communication method or a wireless communication method such as Bluetooth, Wireless Fidelity (Wi-Fi), Third Generation (3G), Long-Term Evolution (LTE), or the like.

The training apparatuses, processors, storage devices, data processing apparatuses, memories, sensors, input devices, output devices, communication devices, training apparatus 1000, processor 1010, storage device 1020, data processing apparatus 1100, processor 1110, memory 1120, sensor 1130, input device 1140, output device 1150, communication device 1160, and other apparatuses, devices, units, modules, and components described herein with respect to FIGS. 1-11 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions used herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. A processor-implemented neural network method, the method comprising:
determining an adaptive parameter and an adaptive mask of a current task to be learned among a plurality of tasks of a neural network;
determining a model parameter of the current task based on the adaptive parameter, the adaptive mask, and a shared parameter of the plurality of tasks; and
training the model parameter and an adaptive parameter of a previous task with respect to the current task,
wherein the adaptive parameter of the previous task and the shared parameter are trained with respect to the previous task.

2. The method of claim 1, wherein the training comprises training the adaptive parameter of the previous task such that a change in a model parameter of the previous task is minimized as the shared parameter is trained with respect to the current task.

3. The method of claim 1, wherein the training comprises training the model parameter based on training data of the current task.

4. The method of claim 1, wherein the determining of the model parameter comprises determining the model parameter of the current task by applying the adaptive mask of the current task to the shared parameter and then adding the adaptive parameter to a result of the applying.

5. The method of claim 1, wherein the determining of the adaptive parameter and the adaptive mask comprises determining the adaptive parameter based on the shared parameter trained with respect to the previous task, and determining the adaptive mask at random.

6. The method of claim 1, wherein the determining of the adaptive parameter and the adaptive mask, the determining of the model parameter, and the training are iteratively performed with respect to each of the plurality of tasks.

7. The method of claim 1, further comprising:
grouping a plurality of adaptive parameters of the plurality of tasks into a plurality of groups; and
decomposing each of the adaptive parameters into a locally shared parameter shared by adaptive parameters grouped into a same group and a second adaptive parameter sparser than the respective adaptive parameter, based on whether elements included in each of the adaptive parameters grouped into the same group satisfy a predetermined condition.

8. The method of claim 7, wherein the model parameter of the current task is determined based on the shared parameter, the locally shared parameter of the group to which the current task belongs, and a second adaptive parameter and the adaptive mask of the current task.

9. The method of claim 1, wherein a structure of the neural network is maintained unchanged, and a connection weight between nodes included in the neural network is determined based on the model parameter.

10. The method of claim 1, further comprising obtaining output data based on the trained model parameter and input data to be inferred.

11. A non-transitory computer-readable storage medium storing instructions that, when executed by a processor, configure the processor to perform the method of claim 1.

12. A processor-implemented neural network method, the method comprising:
selecting an adaptive parameter and an adaptive mask of a target task to be performed among a plurality of tasks of a neural network;
determining a model of the target task based on the adaptive parameter, the adaptive mask, and a shared parameter of the plurality of tasks; and
obtaining output data from the model by inputting input data to be inferred into the determined model.

13. The method of claim 12, wherein the determining of the model comprises determining the model parameter of the target task by applying the adaptive mask of the target task to the shared parameter and adding the adaptive parameter to a result of the applying, and determining a connection weight between nodes included in the neural network based on the model parameter.

14. The method of claim 12, wherein
the adaptive parameter is among adaptive parameters of the plurality of tasks grouped into a plurality of groups, and
the adaptive parameter is determined based on a locally shared parameter of a group to which the target task belongs and a second adaptive parameter corresponding to the target task and being sparser than the adaptive parameter.

15. The method of claim 12, wherein an adaptive parameter of a task to be removed from among the plurality of tasks is deleted.

16. The method of claim 12, wherein the plurality of tasks have a same data type to be input into the neural network.

17. A neural network apparatus, the apparatus comprising:
one or more processors configured to:
determine an adaptive parameter and an adaptive mask of a current task to be learned among a plurality of tasks of a neural network,
determine a model parameter of the current task based on the adaptive parameter, the adaptive mask, and a shared parameter of the plurality of tasks, and
train the model parameter and an adaptive parameter of a previous task with respect to the current task,
wherein the adaptive parameter of the previous task and the shared parameter are trained with respect to the previous task.

18. The apparatus of claim 17, wherein, for the training, the one or more processors are configured to train the adaptive parameter of the previous task such that a change in a model parameter of the previous task is minimized as the shared parameter is trained with respect to the current task.

19. The apparatus of claim 17, wherein, for the training, the one or more processors are configured to train the model parameter based on training data of the current task.

20. The apparatus of claim 17, wherein, for the determining of the model parameter, the one or more processors are configured to determine the model parameter of the current task by applying the adaptive mask of the current task to the shared parameter and then adding the adaptive parameter thereto.

21. A neural network apparatus, the apparatus comprising:
one or more processors configured to:
select an adaptive parameter and an adaptive mask of a target task to be performed among a plurality of tasks of a neural network,
determine a model of the target task based on the adaptive parameter, the adaptive mask, and a shared parameter of the plurality of tasks, and
obtain output data from the model by inputting input data to be inferred into the determined model.
